(19) United States
(12) Patent Application Publication
(10) Pub. No.: US 2021/0370222 A1
(43) Pub. Date: Dec. 2, 2021

(54) HYDROGEN GAS SUPPLY DEVICE

(71) Applicant: KABUSHIKI KAISHA KOBE SEIKO SHO (KOBE STEEL, LTD.), Hyogo (JP)

(72) Inventors: Naofumi KANEI, Takasago-shi, Hyogo (JP); Daisuke WADA, Takasago-shi, Hyogo (JP); Koichiro HASHIMOTO, Takasago-shi (JP)

(73) Assignee: KABUSHIKI KAISHA KOBE SEIKO SHO (KOBE STEEL, LTD.), Hyogo (JP)

(21) Appl. No.: 17/199,530

(22) Filed: Mar. 12, 2021

(30) Foreign Application Priority Data
May 28, 2020 (JP) 2020-093157

(51) Int. Cl. B01D 53/04; B01D 46/00; F17C 7/00

(52) U.S. Cl. CPC B01D 53/0446; B01D 46/0036; F17C 7/00; H01M 8/0675; B01D 2257/30; B01D 2259/4525; B01D 2253/102

(57) ABSTRACT

To provide a hydrogen gas supply device with which pressure resistance of a filter that catches sulfur components contained in a hydrogen gas is improved. A hydrogen gas supply device for a hydrogen station includes a compression portion that compresses a hydrogen gas by reciprocating motion of a piston, in which a piston ring containing sulfur components is mounted on the piston, a filter arranged on the downstream side of the compression portion, the filter that catches sulfur components contained in the hydrogen gas, and a first pipe connecting the compression portion and the filter. The filter includes an element portion having activated carbon onto which the sulfur components contained in the hydrogen gas are absorbable, and a steel housing portion that houses the element portion, in which a gas introduction passage that communicates with the first pipe and guides the hydrogen gas to the element portion is formed.

### BACKGROUND OF THE INVENTION

### Field of the Invention

The present invention relates to a hydrogen gas supply device.

### Description of the Related Art

In a hydrogen station, a hydrogen gas supply device that compresses a hydrogen gas of fuel to predetermined pressure and supplies the compressed high-pressure hydrogen gas to a dispenser is installed. In this hydrogen gas supply device, a reciprocating compressor is used, and a piston ring made of a material containing sulfur components may sometimes be mounted on a piston thereof. JP 6533631 B1 describes a piston ring containing polyphenylene sulfide, etc. as an additive material.

When a piston ring containing sulfur components is used in a compressor for a hydrogen station, the sulfur components contained in the piston ring may be gasified during an action of compressing a hydrogen gas and may be mixed into the hydrogen gas. In this case, the hydrogen gas containing the sulfur components which are impurities is filled into a fuel cell vehicle. Thus, there is a possibility that the sulfur components badly influence on normal operations of a fuel cell (for example, a decrease in power generation efficiency, etc.) Meanwhile, JP 6533631 B1 describes that a filter containing activated carbon, etc. is used in order to ensure a highly-pure compressed gas.

However, in a compressor for a hydrogen station, a hydrogen gas is compressed into a high pressure state of about 80 MPa. Thus, a filter that desulfurizes the hydrogen gas is required to have reasonable pressure resistance. JP 6533631 B1 does not refer to consideration of pressure resistance of the activated carbon filter.

### SUMMARY OF THE INVENTION

The present invention is achieved in consideration with the above problem, and an object thereof is to provide a hydrogen gas supply device with which pressure resistance of a filter that catches sulfur components contained in a hydrogen gas is improved.

A hydrogen gas supply device according to an aspect of the present invention is a hydrogen gas supply device for a hydrogen station, including a compression portion that compresses a hydrogen gas by reciprocating motion of a piston, the compression portion in which a piston ring containing sulfur components is mounted on the piston, a filter arranged on the downstream side of the compression portion, the filter that catches sulfur components contained in the hydrogen gas, and a first pipe connecting the compression portion and the filter. The filter includes an element portion having activated carbon onto which the sulfur components contained in the hydrogen gas are absorbable, and a steel housing portion that houses the element portion, the housing portion in which a gas introduction passage that communicates with the first pipe and guides the hydrogen gas to the element portion is formed.

In this hydrogen gas supply device, the element portion of the filter is housed in the steel housing portion. Therefore, in comparison to a case where the filter does not have the housing portion, it is possible to improve pressure resistance of the filter. Consequently, it is possible to enhance safety at the time of desulfurizing the compressed high-pressure hydrogen gas by the filter.

In the hydrogen gas supply device, the element portion may include a bag body in which the activated carbon is housed, and a pressing portion that presses the bag body.

With this configuration, by pressing the bag body, movement of the activated carbon is suppressed in the bag body. Thereby, it is possible to suppress flapping of the activated carbon at the time of the hydrogen gas passing through in the bag body.

In the hydrogen gas supply device, the element portion may include a holder having a main body portion which is formed in a hollow cylinder that houses the bag body, and a lid portion that closes an opening of the main body portion. The lid portion may press the bag body as the pressing portion in a state where the lid portion is attached to the main body portion.

With this configuration, only by housing the bag body in which the activated carbon is included in the main body portion of the holder and attaching the lid portion to the main body portion, it is possible to easily press the bag body.

In the hydrogen gas supply device, the lid portion may have a screwed portion to be inserted to the inside of the main body portion and screwed to an inner surface of the main body portion.

With this configuration, it is possible to more reliably press the bag body by the lid portion. Thus, the movement of the activated carbon can be more reliably suppressed.

In the hydrogen gas supply device, the lid portion may be formed in a hollow cylinder in which a hole through which the hydrogen gas is capable of passing is formed in a wall. The holder may be housed in the housing portion so that the hydrogen gas is guided from the gas introduction passage to the hole.

With this configuration, a rectification effect acts on the hydrogen gas at the time of the hydrogen gas passing through the hole of the lid portion. Thus, it is possible to suppress generation of a turbulent flow in the filter. Thereby, the flapping of the activated carbon in the bag body can be more effectively suppressed.

In the hydrogen gas supply device, the element portion may include a dust collection portion arranged on the downstream side of the bag body in the housing portion. The dust collection portion may remove the powdery activated carbon contained in the hydrogen gas after passing through the bag body.

With this configuration, by catching the powdery activated carbon possibly contained in the hydrogen gas in the dust collection portion, it is possible to prevent a flow of the activated carbon to the dispenser side of the hydrogen station.

The hydrogen gas supply device may further include a check valve arranged on at least one of the upstream side and the downstream side of the filter on the downstream side of the compression portion.

With this configuration, it is possible to suppress a back-flow of the hydrogen gas in the filter. As a result, it is possible to suppress emission of the sulfur components absorbed onto the activated carbon.

In the hydrogen gas supply device, a purging passage through which a purge gas is guided to the inside of the housing portion may be formed in the housing portion. The hydrogen gas supply device may further include a purging pipe communicating with the purging passage, the purging pipe through which the purge gas is guided from a purge gas supply source to the purging passage.

With this configuration, at the time of maintenance of the filter, it is possible to easily purge the hydrogen gas in the housing portion.

In the hydrogen gas supply device, a check valve may be arranged in the first pipe. The hydrogen gas supply device may further include an upstream-side purging pipe branching from a part of the first pipe on the downstream side of the check valve, the upstream-side purging pipe through which the purge gas is guided from a purge gas supply source into the first pipe, and a downstream-side purging pipe branching from a second pipe which is connected to an outlet of the hydrogen gas in the filter.

With this configuration, even in a case where a housing portion in which no purging passage is formed is used, it is possible to easily purge the hydrogen gas in the housing portion. It is also possible to inhibit the purge gas introduced into the first pipe from flowing into the compression portion by the check valve.

As clear from the description above, according to the present invention, it is possible to provide the hydrogen gas supply device with which the pressure resistance of the filter that catches the sulfur components contained in the hydrogen gas is improved.

### BRIEF DESCRIPTION OF THE DRAWINGS

FIG. 1 is a schematic view showing a configuration of a hydrogen station in a first embodiment of the present invention.

FIG. 2 is a schematic view showing a configuration of a hydrogen gas supply device according to the first embodiment of the present invention.

FIG. 3 is a sectional view schematically showing a configuration of a filter in the first embodiment of the present invention.

FIG. 4 is a schematic view showing a configuration of a hydrogen gas supply device according to a second embodiment of the present invention.

FIG. 5 is a schematic view for explaining another embodiment of the present invention.

### DESCRIPTION OF THE PREFERRED EMBODIMENTS

Hereinafter, a hydrogen gas supply device according to embodiments of the present invention will be described in detail with reference to the drawings.

### First Embodiment

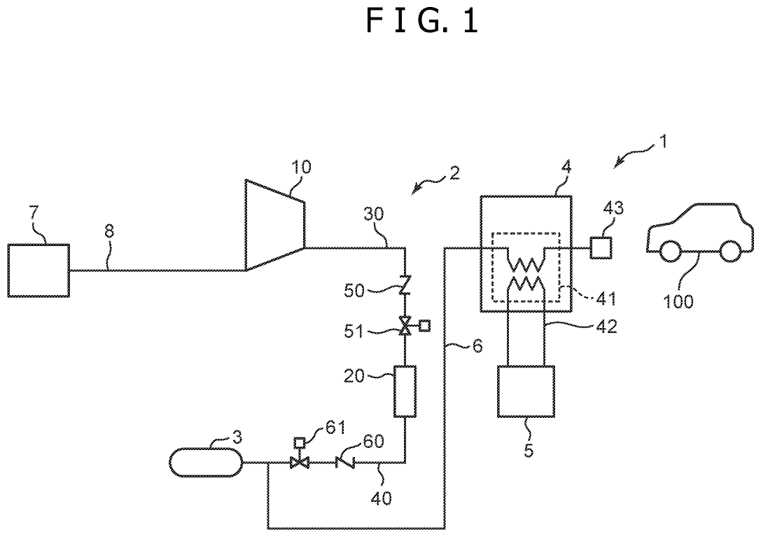

First, the entire configuration of a hydrogen station 1 including a hydrogen gas supply device 2 according to a first embodiment of the present invention will be described based on FIG. 1. The hydrogen station 1 is a facility for filling a hydrogen gas of fuel into a fuel cell vehicle 100, and mainly includes the hydrogen gas supply device 2, a pressure accumulator 3, a dispenser 4.

The hydrogen gas supply device 2 has a compressor 10 that compresses a hydrogen gas supplied from a trailer tank 7, and supplies the compressed high-pressure hydrogen gas to the pressure accumulator 3. In the present embodiment, discharge pressure of the compressor 10 is about 80 MPa. However, the present invention is not limited to this. A detailed configuration of the hydrogen gas supply device 2 will be described later.

The pressure accumulator 3 is arranged on the downstream side of the compressor 10, and temporarily stores the high-pressure hydrogen gas discharged from the compressor 10. Although only one pressure accumulator 3 is shown in FIG. 1, the present invention is not limited to this but plural pressure accumulators 3 may be provided.

The dispenser 4 is to fill the hydrogen gas fed from the pressure accumulator 3 into the fuel cell vehicle 100. As shown in FIG. 1, a pre-cooler 41 is built in the dispenser 4, and the pre-cooler 41 is respectively connected to a supply passage 6 of the hydrogen gas and a brine flow passage 42. The hydrogen gas supplied from the pressure accumulator 3 to the dispenser 4 via the supply passage 6 is cooled down through heat exchange with brine in the pre-cooler 41. The cooled hydrogen gas is filled into a filling port (not shown) of the fuel cell vehicle 100 from a nozzle 43.

Meanwhile, the brine after heat exchange with the hydrogen gas in the pre-cooler 41 is cooled down by a freezer 5, and then supplied to the pre-cooler 41 again via the brine flow passage 42. That is, the brine is circulated between the pre-cooler 41 and the freezer 5 via the brine flow passage 42.

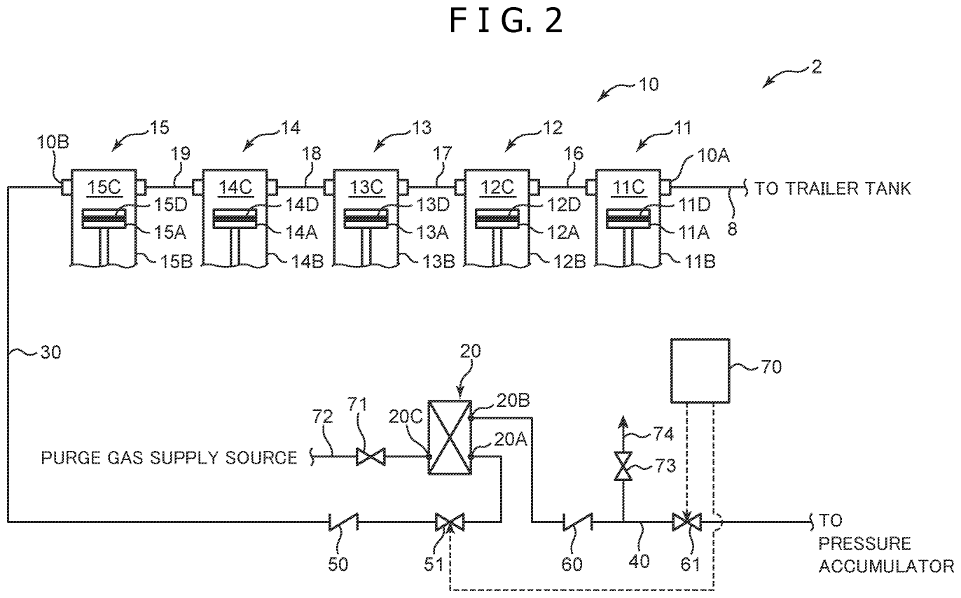

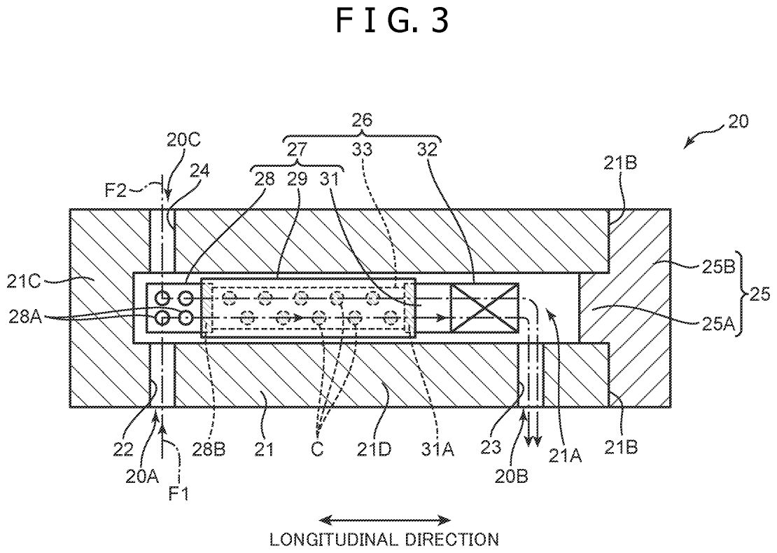

Next, the configuration of the hydrogen gas supply device 2 according to the present embodiment will be described in detail based on FIGS. 2 and 3. As shown in FIG. 2, the hydrogen gas supply device 2 mainly includes the compressor 10, a filter 20, a first pipe 30, a second pipe 40, a first check valve 50, a second check valve 60, a first on/off valve 51, a second on/off valve 61, a purging pipe 72, a purging valve 71, a downstream-side purging pipe 74, and a downstream-side purging valve 73. Hereinafter, these constituent elements will be respectively described.

The compressor 10 is a reciprocation type compressor that compresses the hydrogen gas by reciprocating motion of a piston, and is a five-stage compressor in which five compression portions 11 to 15 are arranged in series (a first compression portion 11, a second compression portion 12, a third compression portion 13, a fourth compression portion 14, and a fifth compression portion 15). The first compression portion 11 includes a first cylinder 11B inside which a first compression chamber 11C that suctions the hydrogen gas is formed, a first piston 11A arranged in the first cylinder 11B, the first piston 11A that reciprocates in the first cylinder 11B so that the volume of the first compression chamber 11C is changed, and a first piston ring 11D mounted on an outer peripheral portion of the first piston 11A. A suction port 10A of the first cylinder 11B is connected to the trailer tank 7 via a receiving pipe 8 (FIGS. 1, 2).

The first piston ring 11D is a member for suppressing gas leakage from the first compression chamber 11C, and seals a clearance between an inner surface of the first cylinder 11B and an outer peripheral surface of the first piston 11A. The first piston ring 11D is made of a material containing sulfur components, for example, a resin material of polyphenylene sulfide, etc. However, the present invention is not limited to this. The second to fifth compression portions 12 to 15 basically have the same configuration as the first compression portion 11. Thus, details of constituent elements will not be described (second to fifth compression chambers 12C to 15C, second to fifth cylinders 12B to 15B, second to fifth pistons 12A to 15A, and second to fifth piston rings 12D to 15D).

As shown in FIG. 2, adjacent compression portions among the first to fifth compression portions 11 to 15 are connected to each other by a connection pipe. Specifically, a discharge port of the first compression portion 11 and a suction port of the second compression portion 12 are connected to each other by a first connection pipe 16, a discharge port of the second compression portion 12 and a suction port of the third compression portion 13 are connected to each other by a second connection pipe 17, a discharge port of the third compression portion 13 and a suction port of the fourth compression portion 14 are connected to each other by a third connection pipe 18, and a discharge port of the fourth compression portion 14 and a suction port of the fifth compression portion 15 are connected to each other by a fourth connection pipe 19.

The filter 20 is to catch the sulfur components contained in the hydrogen gas and arranged on the downstream side of the compressor 10. As described above, the piston rings used in the compressor 10 contain the sulfur components. Thus, during a compression action, the sulfur components may be gasified and as a result, the sulfur components may be mixed into the hydrogen gas. Meanwhile, by arranging the filter 20 in a later stage of the compressor 10 and removing the sulfur components in the hydrogen gas, it is possible to prevent the sulfur components from mixing into the fuel cell vehicle 100 (FIG. 1).

The filter 20 in the present embodiment is to remove the sulfur components from the hydrogen gas by absorption onto activated carbon. As shown in FIG. 2, an inlet 20A of the hydrogen gas, an outlet 20B of the hydrogen gas, and an inlet 20C of a purge gas are respectively provided in the filter 20. A detailed configuration of the filter 20 will be described later.

The first pipe 30 is a pipe connecting the compressor 10 and the filter 20, and a flow passage of the hydrogen gas is formed inside. An upstream end of the first pipe 30 is connected to a discharge port 10B of the compressor 10 (fifth compression portion 15), and a downstream end of the first pipe 30 is connected to the inlet 20A of the filter 20.

The second pipe 40 is a pipe connecting the filter 20 and the pressure accumulator 3 (FIG. 1), and a flow passage of the hydrogen gas is formed inside. An upstream end of the second pipe 40 is connected to the outlet 20B of the filter 20, and a downstream end of the second pipe 40 is connected to an inlet of the pressure accumulator 3. As shown in FIG. 1, an upstream end of the supply passage 6 is connected to the second pipe 40.

The first check valve 50 is to prevent a back-flow of the hydrogen gas at the time of stoppage of the compressor 10, and is arranged on the downstream side of the compressor 10 and the upstream side of the filter 20, that is, in the first pipe 30. The second check valve 60 is to prevent a back-flow of the hydrogen gas at the time of stoppage of the compressor 10 as well as the first check valve 50, and is arranged on the downstream side of the filter 20 and the upstream side of the pressure accumulator 3, that is, in the second pipe 40.

The first on/off valve 51 is a valve that switches between distribution of the hydrogen gas in the first pipe 30 and stoppage of the distribution, and is arranged on the downstream side of the first check valve 50 in the first pipe 30. The second on/off valve 61 is a valve that switches between distribution of the hydrogen gas in the second pipe 40 and stoppage of the distribution, and is arranged on the downstream side of the second check valve 60 in the second pipe 40.

The hydrogen gas supply device 2 further includes a control portion 70 that switches between opening and closing of the first on/off valve 51 and the second on/off valve 61. The control portion 70 switches the first on/off valve 51 and the second on/off valve 61 respectively from an opened state to a closed state based on a signal to stop supply of the hydrogen gas to the dispenser 4 (FIG. 1).

The purging pipe 72 is a pipe for guiding the purge gas from a purge gas supply source into the filter 20. As the purge gas supply source, for example, a nitrogen gas source can be used. However, the present invention is not limited to this. An upstream end of the purging pipe 72 is connected to the purge gas supply source, and a downstream end of the purging pipe 72 is connected to the inlet 20C of the purge gas in the filter 20.

The purging valve 71 is an on/off valve that switches between introduction of the purge gas from the purge gas supply source into the filter 20 via the purging pipe 72 and stoppage of the introduction, and is arranged in the purging pipe 72. Although the purging valve 71 is, for example, a manually-operated valve, the present invention is not limited to this.

The downstream-side purging pipe 74 is a pipe used at the time of purging the hydrogen gas in the filter 20 and branches from a part of the second pipe 40 between the second check valve 60 and the second on/off valve 61. The downstream-side purging valve 73 that switches between an inflow of the gas from the second pipe 40 to the downstream-side purging pipe 74 and stoppage of the inflow is arranged in the downstream-side purging pipe 74.

Next, the configuration of the filter 20 will be described in detail based on FIG. 3. The filter 20 mainly includes an element portion 26 having activated carbon C onto which the sulfur components contained in the hydrogen gas are absorbable, a steel (such as SUS) housing portion 21 that houses the element portion 26, and a flange lid 25. Hereinafter, these constituent elements will be respectively described.

The housing portion 21 is formed in a bottomed cylindrical shape inside which a hollow portion 21A is formed, and has a pressure resistant structure with which the housing portion is resistant to high pressure (such as 80 MPa) of the compressed hydrogen gas. As shown in FIG. 3, the housing portion 21 includes a bottom portion 21C, and a cylinder wall portion 21D extending in the longitudinal direction from the bottom portion 21C to enclose the hollow portion 21A.

The housing portion 21 is manufactured by preparing a cylindrical solid steel member, cutting a radially center portion from one end surface of the steel member to the other end surface, and forming the columnar hollow portion 21A. After that, the element portion 26 is arranged in the hollow portion 21A, and an opening of the hollow portion 21A is closed by the flange lid 25.

As shown in FIG. 3, on one side of the housing portion 21 with respect to the center in the longitudinal direction (left side in FIG. 3), a gas introduction passage 22 and a purging passage 24 passing through the cylinder wall portion 21D in the radial direction are respectively formed. The gas introduction passage 22 and the purging passage 24 are respectively formed at different positions in the circumferential direction in the housing portion 21. Meanwhile, on the other side of the housing portion 21 with respect to the center in the longitudinal direction (right side in FIG. 3), a gas withdrawal passage 23 passing through the cylinder wall portion 21D in the radial direction is formed.

The gas introduction passage 22 is a passage for guiding the hydrogen gas to the element portion 26 (hollow portion 21A). The gas introduction passage 22 includes the inlet 20A connected to the downstream end of the first pipe 30 (FIG. 2), and communicates with the first pipe 30 and the hollow portion 21A.

The gas withdrawal passage 23 is a passage for guiding the gas passing through the element portion 26 to the outside of the filter 20 (second pipe 40, FIG. 2). The gas withdrawal passage 23 includes the outlet 20B connected to the upstream end of the second pipe 40 (FIG. 2), and communicates with the second pipe 40 and the hollow portion 21A. In such a way, in the filter 20, a flow passage through which the gas flows in the order of the gas introduction passage 22, the hollow portion 21A, and the gas withdrawal passage 23 is formed.

The purging passage 24 is a passage for guiding the purge gas to the inside (hollow portion 21A) of the housing portion 21. The purging passage 24 includes the inlet 20C connected to the downstream end of the purging pipe 72, and communicates with the purging pipe 72 and the hollow portion 21A. With this configuration, the purge gas is guided from the purge gas supply source to the purging passage 24 via the purging pipe 72, and after that, the purge gas is guided to the hollow portion 21A.

The element portion 26 includes a bag body 33 in which the activated carbon C is housed, a holder 27 that houses the bag body 33, and a dust collection portion 32. The activated carbon C is formed in, for example, a pellet shape, and a number of pieces of the activated carbon are charged in the bag body 33. The bag body 33 is formed in a mesh form through which the gas can pass, and has a shape elongated in the longitudinal direction of the housing portion 21.

The holder 27 includes a main body portion 29 formed in a hollow cylinder that houses the bag body 33, a first lid portion 28 that closes an opening of the main body portion 29 on the one end side in the longitudinal direction (left end side in FIG. 3), and a second lid portion 31 that closes an opening of the main body portion 29 on the other end side in the longitudinal direction (right end side in FIG. 3). The main body portion 29 is a metal pipe member extending in the longitudinal direction of the housing portion 21, the pipe member whose both ends are opened and whose outer diameter is smaller than an inner diameter of the housing portion 21A.

The first lid portion 28 is a metal member formed in, for example, a hollow cylindrical shape, and is attached on the one end side of the main body portion 29. More specifically, the first lid portion 28 has a screwed portion 28B inserted to the inside of the main body portion 29 from the opening on the one end side. A female screw is formed in a region on an inner surface of the main body portion 29 on the one end side, and a male screw formed on an outer peripheral surface of the screwed portion 28B is screwed into the female screw. Thereby, the first lid portion 28 is fixed to the main body portion 29.

In a state to be attached to the main body portion 29 as described above, the first lid portion 28 presses the bag body 33 from the one side in the longitudinal direction to the other side (from the left side to the right side in FIG. 3) as a pressing portion. That is, by screwing the screwed portion 28B of the first lid portion 28 from the opening on the one end side to the inside of the main body portion 29, the bag body 33 is pressed, and thereby, the activated carbon C housed in the bag body 33 is less easily moved.

In the first lid portion 28, a number of holes 28A through which the hydrogen gas can pass are formed to pass through a cylindrical wall in the radial direction. The plural holes 28A are formed to be spaced from each other in the cylindrical axis direction and the circumferential direction of the first lid portion 28. The holder 27 is housed in the housing portion 21 so that the hydrogen gas is guided from the gas introduction passage 22 to the holes 28A. That is, the holder 27 is inserted into the hollow portion 21A from the first lid portion 28 side to the bottom portion 21C. In a state where insertion of the holder 27 is completed, as shown in FIG. 3, the holes 28A face (oppose) the gas introduction passage 22 and the purging passage 24.

The second lid portion 31 is a metal member formed in, for example, a hollow cylindrical shape, and is attached on the other end side of the main body portion 29. More specifically, the second lid portion 31 has an insertion portion 31A inserted from the opening on the other end side to the inside of the main body portion 29. As shown in FIG. 3, the bag body 33 is sandwiched by the first lid portion 28 (screwed portion 28B) and the second lid portion 31 (insertion portion 31A) in the longitudinal direction.

Inner spaces of the first lid portion 28, the main body portion 29, and the second lid portion 31 communicate with each other. Therefore, the gas flows from the inner space of the first lid portion 28 to the bag body 33, and the gas passing through the bag body 33 flows out to the inner space of the second lid portion 31.

The dust collection portion 32 is to remove the powdery activated carbon contained in the hydrogen gas after passing through the bag body 33, and is, for example, a filter made of non-woven fabric, etc. As shown in FIG. 3, the dust collection portion 32 is arranged on the downstream side of the bag body 33 in the housing portion 21 (hollow portion 21A), more specifically arranged closer to the gas withdrawal passage 23 rather than the second lid portion 31.

The flange lid 25 is to close the opening of the hollow portion 21A, and is fixed to an end surface 21B of the housing portion 21 on the opening side by fastening tools (not shown) such as bolts and nuts. The flange lid 25 has a disc-shaped flange portion 25B, and a columnar portion 25A projecting from a center portion of the flange portion 25B, and the columnar portion 25A is inserted into the hollow portion 21A. Between the columnar portion 25A and the dust collection portion 32, an elastic body (such as a spring) (not shown) is arranged.

Flows of the hydrogen gas and the purge gas in the filter 20 respectively at the time of supplying and at the time of stopping supply of the hydrogen gas to the dispenser 4 (FIG. 1) will be described.

A dashed-dotted arrow F1 in FIG. 3 schematically shows the flow of the hydrogen gas in the filter 20 at the time of supplying the hydrogen gas to the dispenser 4. As shown in FIG. 3, the hydrogen gas passes through the gas introduction passage 22, flows into the hollow portion 21A, and then flows into the inner space of the first lid portion 28 from the holes 28A. Successively, the hydrogen gas flows in the bag body 33 from the one side to the other side in the longitudinal direction (from the left side to the right side in FIG. 3), and the sulfur components contained in the hydrogen gas are absorbed onto the activated carbon C during the process. After that, the powdery activated carbon is removed by the hydrogen gas passing through the dust collection portion 32, and then the hydrogen gas flows out to the outside of the filter 20 (second pipe 40, FIG. 2) via the gas withdrawal passage 23. The desulfurized hydrogen gas is temporarily stored in the pressure accumulator 3, and then supplied to the dispenser 4.

A dashed-dotted arrow F2 in FIG. 3 schematically shows the flow of the purge gas (nitrogen gas in the present embodiment) in the filter 20 at the time of stoppage of supply of the hydrogen gas to the dispenser 4 (for example, the time of maintenance of the filter 20).

First, the compressor 10 is stopped, the first on/off valve 51 and the second on/off valve 61 are respectively switched from an opened state to a closed state, and the purging valve 71 and the downstream-side purging valve 73 are respectively switched from a closed state to an opened state. Thereby, the purge gas passes through the purging passage 24 and flows into the hollow portion 21A. The purge gas flows into the inner space of the first lid portion 28 from the holes 28A, passes through the inner space of the main body portion 29 (bag body 33), the inner space of the second lid portion 31, and the dust collection portion 32 in this order, and then is withdrawn to the outside of the filter 20 (second pipe 40). After that, the purge gas is emitted through the downstream-side purging pipe 74. In such a way, the hydrogen gas in the filter 20 is purged by the nitrogen gas.

As described above, in the hydrogen gas supply device 2 according to the present embodiment, the element portion 26 of the filter 20 is housed in the steel housing portion 21. Therefore, in comparison to a case where the filter 20 does not have the housing portion 21, it is possible to improve pressure resistance of the filter 20. Consequently, it is possible to enhance safety at the time of desulfurizing the compressed high-pressure hydrogen gas by the filter 20. In addition, by pressing the bag body 33, movement of the activated carbon C is suppressed in the bag body 33. Thereby, it is possible to suppress flapping of the activated carbon C at the time of the hydrogen gas passing through in the bag body 33.

In the hydrogen gas supply device 2, only by housing the bag body 33 in which the activated carbon C is included in the main body portion 29 of the holder 27 and attaching the first lid portion 28 to the main body portion 29, it is possible to easily press the bag body 33. In particular, by the first lid portion 28 having the screwed portion 28B, it is possible to more reliably press the bag body 33. Thus, the movement of the activated carbon C can be more reliably suppressed. A rectification effect acts on the hydrogen gas at the time of the hydrogen gas passing through the holes 28A of the first lid portion 28. Thus, it is possible to suppress generation of a turbulent flow in the filter 20. Thereby, the flapping of the activated carbon C in the bag body 33 can be more effectively suppressed. In the element portion 26, by catching the powdery activated carbon C possibly contained in the hydrogen gas in the dust collection portion 32, it is possible to prevent a flow of the activated carbon C to the dispenser 4 side of the hydrogen station 1.

The hydrogen gas supply device 2 includes the first check valve 50 arranged on the downstream side of the fifth compression portion 15 and the upstream side of the filter 20, and the second check valve 60 arranged on the downstream side of the filter 20. With this configuration, it is possible to suppress a back-flow of the hydrogen gas in the filter 20. As a result, it is possible to suppress emission of the sulfur components absorbed onto the activated carbon C.

The hydrogen gas supply device 2 includes the purging pipe 72 communicating with the purging passage 24, the purging pipe through which the purge gas is guided from the purge gas supply source to the purging passage 24. Thereby, at the time of maintenance of the filter 20, it is possible to easily purge the hydrogen gas in the housing portion 21.

### Second Embodiment

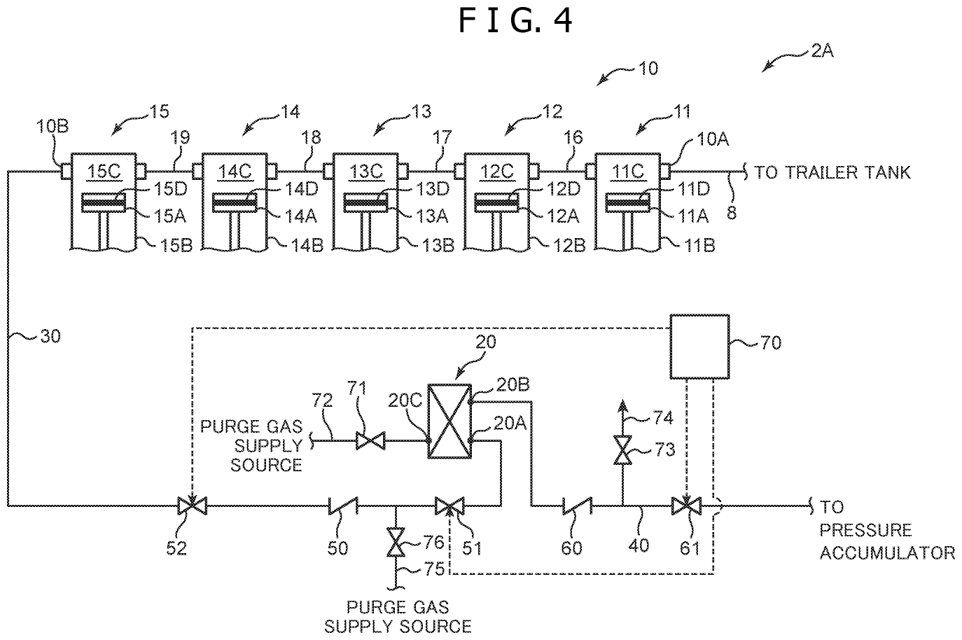

Next, a configuration of a hydrogen gas supply device 2A according to a second embodiment of the present invention will be described based on FIG. 4. The hydrogen gas supply device 2A according to the second embodiment basically has the same configuration and exerts the same effect as the hydrogen gas supply device 2 according to the first embodiment but is different in a point that an upstream-side purging pipe 75 branching from the first pipe 30 is further provided. Hereinafter, only the point different from the first embodiment will be described.

The upstream-side purging pipe 75 is a pipe for guiding a purge gas from a purge gas supply source such as a nitrogen gas source into the first pipe 30. The purge gas supply source is connected to an upstream end of the upstream-side purging pipe 75, and a downstream end of the upstream-side purging pipe 75 is connected to a part of the first pipe 30 on the downstream side of the first check valve 50 and the upstream side of the first on/off valve 51. That is, the upstream-side purging pipe 75 branches from the part of the first pipe 30 on the downstream side of the first check valve 50 and the upstream side of the first on/off valve 51.

An upstream-side purging valve 76 that switches between an inflow of the purge gas into the first pipe 30 and stoppage of the inflow is arranged in the upstream-side purging pipe 75. In a part of the first pipe 30 on the upstream side of the first check valve 50, a third on/off valve 52 that switches between distribution of a hydrogen gas and stoppage of the distribution is arranged. Opening/closing of this third on/off valve 52 is controlled by the control portion 70.

In the second embodiment, as described below, it is possible to purge the hydrogen gas in the filter 20 without using the purging pipe 72 and the purging valve 71. Therefore, in the second embodiment, the purging pipe 72 and the purging valve 71 may be omitted and the purging passage 24 (FIG. 3) is not necessarily formed in the housing portion 21.

First, after the compressor 10 is stopped, the second on/off valve 61 and the third on/off valve 52 are respectively switched from an opened state to a closed state, and the upstream-side purging valve 76 and the downstream-side purging valve 73 are respectively switched from a closed state to an opened state. Thereby, the purge gas flows into the first pipe 30 via the upstream-side purging pipe 75, and flows into the filter 20 from the inlet 20A. The purge gas passes through the gas introduction passage 22 and flows into the hollow portion 21A. After that, as well as the first embodiment, the purge gas flows through the inside of the filter 20, flows out from the outlet 20B, and is emitted via the downstream-side purging pipe 74.

### Other Embodiment

The embodiments described herein should be interpreted not as restrictions but as examples in all respects. The range of the present invention is indicated not by the description above but by the claims. The present invention intends to include all changes having meanings which are equivalent to or within the claims. Therefore, the following embodiments are also included within the range of the present invention.

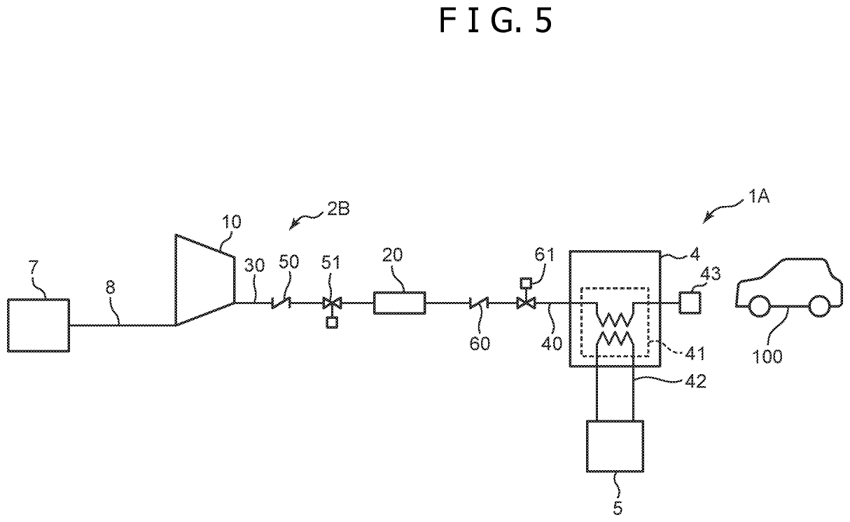

As shown in FIG. 5, in a hydrogen station 1A in which no pressure accumulator is installed, the hydrogen gas supply device of the present invention may be applied. In this case, the downstream end of the second pipe 40 is connected to the pre-cooler 41 of the dispenser 4, and a hydrogen gas is directly supplied from a hydrogen gas supply device 2B to the dispenser 4.

In the hydrogen gas supply device 2 according to the first embodiment, only the first check valve 50 may be omitted, only the second check valve 60 may be omitted, or both the first check valve 50 and the second check valve 60 may be omitted.

In the first embodiment, the case where all the first to fifth piston rings 11D to 15D are made of the material containing the sulfur components is described. However, the present invention is not limited to this. For example, only the fourth piston ring 14D among the first to fifth piston rings 11D to 15D may be made of the material containing the sulfur components and the first to third, and fifth piston rings 11D to 13D, and 15D may not contain the sulfur components. In this case, the filter 20 is only required to be arranged on the downstream side of the fourth compression portion 14 in which the piston ring containing the sulfur components is used. Thus, the filter 20 may be arranged between the fourth compression portion 14 and the fifth compression portion 15. At this time, a pipe connecting the fourth compression portion 14 and the filter 20 is the first pipe.

The fifth compression portion 15 may be a diaphragm type compression portion.

The upstream-side purging pipe 75 and the downstream-side purging pipe 74 may be used for a purpose other than purging the hydrogen gas in the filter 20.

In the first embodiment, the case where the bag body 33 is pressed by screwing the first lid portion 28 to the main body portion 29 is described. However, a mode of the pressing portion is not limited to this. For example, the bag body 33 may be pressed by utilizing restoring force of an elastic body such as a spring and rubber. The bag body 33 is not always required to be pressed.

The number of stages of the compressor may be four or less or may be six or more. The compressor is not limited to a multi-stage compressor but a single-stage compressor may be used.

The dust collection portion 32 may be omitted.

The holes 28A are not necessarily formed in the first lid portion 28.

The holder 27 may be omitted and the bag body 33 may be directly arranged in the hollow portion 21A.

What is claimed is:

1. A hydrogen gas supply device for a hydrogen station, comprising:
a compression portion that compresses a hydrogen gas by reciprocating motion of a piston, the compression portion in which a piston ring containing sulfur components is mounted on the piston;
a filter arranged on the downstream side of the compression portion, the filter that catches sulfur components contained in the hydrogen gas; and
a first pipe connecting the compression portion and the filter, wherein
the filter includes:
an element portion having activated carbon onto which the sulfur components contained in the hydrogen gas are absorbable; and
a steel housing portion that houses the element portion, the housing portion in which a gas introduction passage that communicates with the first pipe and guides the hydrogen gas to the element portion is formed.

2. The hydrogen gas supply device according to claim 1, wherein
the element portion includes:
a bag body in which the activated carbon is housed; and
a pressing portion that presses the bag body.

3. The hydrogen gas supply device according to claim 2, wherein
the element portion includes a holder having a main body portion which is formed in a hollow cylinder that houses the bag body, and a lid portion that closes an opening of the main body portion, and
the lid portion presses the bag body as the pressing portion in a state where the lid portion is attached to the main body portion.

4. The hydrogen gas supply device according to claim 3, wherein
the lid portion has a screwed portion to be inserted to the inside of the main body portion and screwed to an inner surface of the main body portion.

5. The hydrogen gas supply device according to claim 4, wherein
the lid portion is formed in a hollow cylinder in which a hole through which the hydrogen gas is capable of passing is formed in a wall, and
the holder is housed in the housing portion so that the hydrogen gas is guided from the gas introduction passage to the hole.

6. The hydrogen gas supply device according to claim 5, wherein
the element portion includes a dust collection portion arranged on the downstream side of the bag body in the housing portion, and
the dust collection portion removes the powdery activated carbon contained in the hydrogen gas after passing through the bag body.

7. The hydrogen gas supply device according to claim 1, further comprising:
a check valve arranged on at least one of the upstream side and the downstream side of the filter on the downstream side of the compression portion.

8. The hydrogen gas supply device according to claim 1, wherein
a purging passage through which a purge gas is guided to the inside of the housing portion is formed in the housing portion,
the hydrogen gas supply device further comprising:
a purging pipe communicating with the purging passage, the purging pipe through which the purge gas is guided from a purge gas supply source to the purging passage.

9. The hydrogen gas supply device according to claim 1, wherein
a check valve is arranged in the first pipe,
the hydrogen gas supply device further comprising:
an upstream-side purging pipe branching from a part of the first pipe on the downstream side of the check valve, the upstream-side purging pipe through which the purge gas is guided from a purge gas supply source into the first pipe; and
a downstream-side purging pipe branching from a second pipe which is connected to an outlet of the hydrogen gas in the filter.
